(19) United States
(12) Patent Application Publication
(10) Pub. No.: US 2006/0275637 A1
(43) Pub. Date: Dec. 7, 2006

(54) ELECTROLYTE MEMBRANE AND PREPARING METHOD THEREOF

(75) Inventors: Satoshi Nakazawa, Hitachi-shi (JP); Shinji Takeda, Hitachi-shi (JP); Kouichi Kamijima, Hitachi-shi (JP); Shoichi Sasaki, Hitachi-shi (JP); Iwao Fukuchi, Hitachi-shi (JP); Akihiro Orita, Hitachi-shi (JP); Hua Zhou, Tokyo (JP); Takeo Yamaguchi, Tokyo (JP)

Correspondence Address: NIXON PEABODY, LLP, 401 9TH STREET, NW, SUITE 900, WASHINGTON, DC, 20004-2128, US

(73) Assignee: THE UNIVERSITY OF TOKYO, Tokyo (JP)

(21) Appl. No.: 11/440,356

(22) Filed: May 25, 2006

Related U.S. Application Data
(60) Provisional application No. 60/739,423, filed on Nov. 25, 2005.

(30) Foreign Application Priority Data
May 26, 2005 (JP) 2005-154441
Sep. 30, 2004 (JP) 2004-287802

(51) Int. Cl. H01M 8/10; B05D 5/12

(52) U.S. Cl. 429/33; 427/115

(57) ABSTRACT

The present invention provides an electrolyte membrane in which permeation of an electrolyte solution such as water and methanol, and swelling by electrolyte solutions are suppressed, and which is excellent in mechanical strength; and providing a preparing method thereof. The present invention relates to an electrolyte membrane comprising a porous substrate with a plurality of pores and a proton conductive polymer composition held in the pores, wherein the proton conductive polymer composition contains an aromatic hydrocarbon resin having proton acid groups, preferably an aromatic hydrocarbon resin selected from a group consisting of polysulfone, polyethersulfone, polyarylate, polyamide imide, polyetherimide, polyimide, polyquinoline, and polyquinoxaline.

### BACKGROUNF OF THE INVENTION

1. Field of the Invention

The present invention relates to an electrolyte membrane, which has a porous substrate with plural pores and a proton conductive polymer composition held in the pores. In particular, it relates to an electrolyte membrane used in a fuel cell.

2. Description of the Related Art

Due to the exhaustion of petroleum resources and aggravation of environmental problems such as global warming, the fuel cell is attracting attention as a clean power source for electric motors. The fuel cell is characterized by operation at low temperature, high power density and size miniaturization potency, and is suitable to use as an in-car battery, a home battery and the like, and is regarded as important.

As the fuel cell, a solid polymer electrolyte fuel cell using a proton conductive polymer composition such as perfluorocarbon polymers (Nafion (R) etc.) having a sulfonate group, as an electrolyte membrane, is known. The membrane thickness of this electrolyte membrane is required to be thin for reducing the electric resistance.

However, when the membrane thickness of the above-described electrolyte membrane consisting of a polymer having sulfonate groups was tried to be made thinner, the convenience of processing and handling of the membrane got worse, so that suitable mechanical strength could not be maintained. Moreover, an influence of a short-circuit phenomenon (crossover) of an anode methanol and a cathode oxidizer through the electrolyte membrane caused by electrolyte membrane swelling has become larger, and melting of the electrolyte membrane (creeping) due to a temperature rise has occurred easily.

As another way to reduce the electrolyte membrane thickness, an electrolyte membrane of a porous polytetrafluoroethylene film impregnated with perfluoro ion exchange resin is known (Patent document 1: JP-B-5-75835). However, although the perfluoro ion exchange resin can, to some extent, suppress swelling against methanol or water, it is inadequate about permeability control of methanol, and there has been a problem in the power-output characteristics of the electrolyte membrane.

### SUMMARY OF THE INVENTION

Problems to be Solved by the Invention

Therefore, the first object of the present invention is to provide an electrolyte membrane in which permeation of an electrolyte solution such as water and methanol and swelling by the electrolyte solution are suppressed, and is excellent in mechanical strength, and to provide preparing method thereof.

The second object of the present invention is to realize an unprecedentedly thin electrolyte membrane and in addition, to provide a low electric-resistance electrolyte membrane with excellent dimensional stability, thermal resistance and chemical resistance, and preparing method thereof.

The third object of the present invention is to provide a membrane electrode assembly utilizing the above-described electrolyte membrane.

The fourth object of the present invention is to provide a fuel cell utilizing the above-described membrane electrode assembly.

Means for Solving the Problem

As a result of eagerly repeated studies in order to solve the above-mentioned problems, the present inventors have found out that they can provide an outstanding electrolyte membrane which conquered the above-mentioned shortcomings, by using a porous substrate having a plurality of pores wherein a proton conductive polymer composition containing an aromatic hydrocarbon resin having proton acid groups is held in all or some of the pores, and then they have completed the present invention. That is, the present invention relates to:

1. An electrolyte membrane comprising a porous substrate having a plurality of pores and a proton conductive polymer composition held in said pores, wherein said proton conductive polymer composition contains an aromatic hydrocarbon resin having proton acid groups.

2. The electrolyte membrane according to the above-mentioned 1, wherein said aromatic hydrocarbon resin is selected from a group consisting of polysulfone, polyethersulfone, polyarylate, polyamide imide, polyetherimide, polyimide, polyquinoline, and polyquinoxaline.

3. The electrolyte membrane according to the above-mentioned 1, wherein said aromatic hydrocarbon resin is polyethersulfone.

4. The electrolyte membrane according to the above-mentioned 1, wherein said proton acid group is selected from a group consisting of a sulfonate group, a carboxylate group, a phosphate group, and a phenolic hydroxyl group.

5. The electrolyte membrane according to the above-mentioned 1, wherein said aromatic hydrocarbon resin comprises a structure given by formula (I) 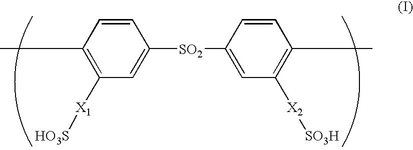
wherein X₁ and X₂ are either the same or different with each other, and are —(ROₘ)ₙ—, where R is an alkylene group, m is 0 or 1, and n is an integer of 0 to 20.
6. The electrolyte membrane according to the above-mentioned 1, wherein said porous substrate is an inorganic material or a heat-resistant polymer.
7. The electrolyte membrane according to the above-mentioned 1, wherein said porous substrate is polyimide and said aromatic hydrocarbon resin is polyethersulfone.
8. The electrolyte membrane according to the above-mentioned 1, wherein said proton conductive polymer composition contains a cross-linking agent.
9. The electrolyte membrane according to the above-mentioned 1, wherein a part of said pores and a part of said aromatic hydrocarbon resin are fixed.
10. The electrolyte membrane according to the above-mentioned 1, wherein the area change rate of said electrolyte membrane after immersion in water at 25° C. for 24 hours is 10% or less; the weight change rate after immersion in a solution containing 3 weight % of H₂O₂ and 5 ppm of FeSO₄ at 80° C. for 1 hour is 10% or less; and the proton conductivity is 0.01 S/cm or more.
11. A method for preparing the electrolyte membrane according to the above-mentioned 1, comprising:

(1) a step of holding monomers and/or oligomers for forming said proton conductive polymer composition in said pores of said porous substrate; and

(2) a step of polymerizing said monomers and/or an oligomers in said pores.

12. The method for preparing the electrolyte membrane according to the above-mentioned 11, wherein each of the monomers and/or the oligomers for forming said proton conductive polymer composition has three or more reactive groups.

13. A method for preparing the electrolyte membrane according to the above-mentioned 1, comprising:

(1) a step of immersing said porous substrate in a solvent solution of said proton conductive polymer composition, to introduce said proton conductive polymer composition into said pores of said porous substrate; and

(2) a step of keeping said porous substrate holding said proton conductive polymer composition at the temperature of 60° C. or higher for at least 1 hour.

14. A membrane electrode assembly using the electrolyte membrane according to the above-mentioned 1.

15. A fuel cell using the membrane electrode assembly according to the above-mentioned 14.

Effect of the Invention

The electrolyte membrane of the present invention has low electric resistance, and when it is used for a fuel cell, internal resistance of the fuel cell can be reduced. Moreover, since the pores of the porous substrate are filled with the proton conductive composition of the present invention to the details without void spaces, the electrolyte membrane of the present invention has very low permeability to oxidizing agent gas (for example, oxygen) at the cathode, or to the methanol at the anode. Furthermore, since the electrolyte membrane of the present invention can be made of a porous substrate excellent in dimensional stability, thermal resistance, and chemical resistance, as a base material, swelling of the electrolyte can be suppressed even under a high temperature, and an electrolyte membrane with a stabilized quality, with suppressed permeation of methanol or oxygen gas, can be provided. Moreover, since it is not decomposed by radical compounds, such as hydrogen peroxide and the like generated inside the electrolyte, a high cell output power can be obtained for a long time stably.

The electrolyte membrane of the present invention is used as an electrolyte membrane for a fuel cell, especially for a solid polymer electrolyte fuel cell and a direct methanol fuel cell. By using it for such a fuel cell, the crossover of a fuel such as methanol and an oxidizer such as O₂ gas can be controlled, and a high cell output power can be obtained for a long time stably.

### BRIEF DESCRIPTION OF THE DRAWINGS

FIG. 1 is a graph illustrating an oxidation resistance test

FIG. 2 is a graph illustrating a methanol permeability test.

FIG. 3 is a graph illustrating a methanol permeability test.

### DETAILED DESCRIPTION OF THE INVENTION

Hereafter, an electrolyte membrane, its preparing method, a membrane electrode assembly and a fuel cell of the present invention are explained in detail.

(1) Electrolyte Membrane

The electrolyte membrane of the present invention comprises a porous substrate having plural pores, and a proton conductive polymer composition held in the pores. The electrolyte membrane is desired to be excellent in proton conductivity, dimensional stability, thermal resistance, and chemical resistance.

Here, the membrane proton conductivity at 25° C. and 100% humidity is preferably 0.01 S/cm or more, more preferably 0.04 S/cm or more, and still more preferably 0.09 S/cm or more. If it is 0.01 S/cm or more, internal resistance of the fuel cell will not extremely increase.

Good dimensional stability and thermal resistance are preferable since swelling of the electrolyte even under a high temperature condition can be suppressed and then the permeation of methanol and oxygen gas can be suppressed.

As for the dimensional stability, when the electrolyte membrane is immersed in 25° C. pure water for 24 hours, its area change rate before and after immersion (%) is preferably 20% or less, more preferably 10% or less, and still more preferably 3% or less. If the area change rate is 20% or less, sufficient adhesion of the electrolyte membrane surface and the catalyst layer can be obtained, interface resistance between the electrolyte membrane and the catalyst layer will not become too large, the swelling of the electrolyte can fully be controlled, and the methanol permeability can be suppressed low.

As for the thermal resistance, it is preferable that physical properties do not change within the use-range of the fuel cell, that is, from −30° C. to 150° C.

As for the chemical resistance, it is preferable that the electrolyte membrane has a high oxidation resistance not to be decomposed by oxidizers such as hydrogen peroxide generated within the electrolyte membrane.

As for the oxidation resistance, when the electrolyte membrane is immersed into a solution containing 3 weight % of H₂O₂ and 5 ppm of FeSO₄ at 80° C. for 1 hour, the weight change before and after the immersion is preferably 10% or less, and more preferably 5% or less. If it is 10% or less, the fuel cell which uses the electrolyte membrane of the present invention will obtain a sufficient long-term stability. Moreover, when the electrolyte membrane is immersed in the solution containing 3 weight % of H₂O₂ and 5 ppm of FeSO₄ at 50° C., the immersion duration for which 10% or less of the weight change rate before and after immersion can be maintained is preferably 3 hours, and more preferably 2 hours.

(1-1) Porous Substrate

The porous substrate used in the present invention is not particularly limited, but may be chosen from known inorganic material and organic material. These porous substrates are preferably excellent in the dimensional stability, the thermal resistance, the chemical resistance, and the mechanical strength.

Specifically, the inorganic material includes ceramics, such as those based on alumina, zirconia, silica, silicon nitride and silicon carbide; glasses; alumina; and complexes thereof.

Various polymers, such as a thermosetting resin or a thermoplastic resin can be selected as the organic material. In particular, heat-resistant polymers are desirable from the point of durability. Here, the heat-resistant polymers refer to resins whose glass transition temperature (Tg) is 150° C. or higher, and preferably 150-300° C. As the heat-resistant polymers, polysulfone, polyethersulfone, polyarylate, polyamide imide, polyetherimide, polyimide, polyquinoline, polyquinoxaline, cross-bridged polyethylene, and mixtures thereof are preferred; wherein, polyquinoline and polyquinoxaline refer to the polymers having following quinoline skeleton and quinoxaline skeleton, respectively.

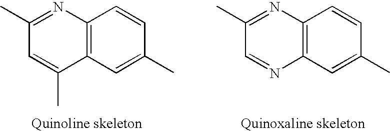

The thickness of the porous substrate of the present invention is suitably, for example, 0.01 to 300 μm, preferably 0.01 to 200 μm, and more preferably 0.1 to 100 μm. If the substrate has the thickness of 0.1 μm or more, sufficient strength is obtained, and is advantageous in its handling and workability, and if the thickness is 300 μm or less, it is suitable since the electric resistance of the obtained electrolyte membrane does not become too large. Moreover, since sulfonate groups which give proton conductivity to the substrate itself, do not need to be introduced into the porous substrate of the present invention, it is not affected by the mechanical strength reduction of the membrane by the sulfonate groups. Therefore, the thickness of the porous substrate of the present invention can be, for example, less than 20 μm, preferably 10 μm or less, and more preferably 1 μm or less.

It is suitable that the pores existing on the porous substrate of the present invention, in which the proton conductive polymer composition is held, are continuous pores. Here, “continuous pores” means the pores which penetrate through the surface and the back of the porous substrate. By the proton conductive polymer composition held within such continuous pores, protons become possible to move from the surface of the porous substrate to its back through these continuous pores. Therefore, the porous substrate of the present invention can allow protons to move through these continuous pores, without being swollen by the electrolytes.

The void content of the porous substrate of the present invention is suitable, for example, to be 10 to 95%, preferably 20 to 90%, and more preferably 40 to 80%. If it is 10% or more, the proton conductive polymer composition can fully be held in the pores of the porous substrate, and sufficient electrolytic conductivity can be obtained. Moreover, if it is 95% or less, practical thin membrane strength can be obtained.

A mean diameter of the pores penetrating through the surface and the back of the porous substrate of the present invention (the mean through pore diameter) is suitable to be 0.001 to 100 μm, preferably 0.005 to 50 μm, and more preferably 0.01 to 10 μm. If the mean through pore diameter is 0.001 μm or more, the proton conductive polymer composition can fully be held in the pores of the porous substrate, and sufficient electrolytic conductivity can be obtained. Moreover, if the mean through pore diameter is below 100 μm, it is suitable because the proton conductive polymer composition can be fixed within the pores without leaking out.

(1-2) Proton Conductive Polymer Composition

Proton conductive polymer composition used in the present invention includes aromatic hydrocarbon resins having proton acid groups, and if necessary, other resins and additives.

(1-2-1) Aromatic Hydrocarbon Resin

An aromatic hydrocarbon resin of the present invention has aromatic groups on its main skeleton of a hydrocarbon based resin. Such an aromatic hydrocarbon resin is preferable in respect of thermal resistance, oxidation resistance, flexibility, and membrane formability. The main skeleton of this aromatic hydrocarbon resin is suitable to be: polyetherketone, polysulfide, polyphosphazene, polyphenylene, polybenzimidazole, polyethersulfone, polyphenylene oxide, polycarbonate, polyurethane, polyamide, polyimide, polyurea, polyquinoline, polyquinoxaline, polysulfone, polysulfonate, polybenzoxazole, polybenzothiazole, polythiazole, polyphenylquinoxaline, polyquinoline, polysiloxane, polytriazine, polydiene, polypyridine, polypyrimidine, polyoxathiazole, polytetrazapyzarene, polyoxazole, polyvinylpyridine, polyvinylimidazole, polypyrrolidone, polyacrylate derivatives, polymethacrylate derivatives, polystyrene derivatives, and the like. Especially from the points of thermal resistance and electrolytic solution resistance (swelling resistance), it is more preferable that any of polysulfone, polyethersulfone, polyarylate, polyamide imide, polyetherimide, polyimide, polyquinoline, or polyquinoxaline is included, and more preferably polyethersulfone is included. The aromatic hydrocarbon resin may be one of, or a mixture of a plurality of the above-described polymers, and may be a copolymerized copolymer of two or more kinds of monomers constituting the above-described polymer.

The number average molecular weight of the aromatic hydrocarbon resin according to the present invention is preferable to be 1,000 to 1,000,000, more preferable to be 5,000 to 500,000 from the viewpoints of strength and workability of the obtained electrolyte membrane, and especially preferable to be 10,000 to 200,000. If the number average molecular weight is 1,000 or more, strength of the obtained electrolyte membrane can fully be maintained, and if it is 1,000,000 or less, sufficient workability can be held.

(1-2-2) Proton Acid Group

The proton acid groups existing in the aromatic hydrocarbon resin may include functional groups easy to emit protons. For example, the proton acid groups preferably contain at least one or more groups selected from a group consisting of:a sulfonate group (—SO₃H), a carboxylate group (—COOH), a phosphate group (—PO₃H₂), an alkylsulfonate group (—(CH₂)ₙSO₃H), an alkylcarboxylate group (—(CH₂)ₙCOOH), an alkylphosphate group (—(CH₂)ₙPO₃H₂), a phenolic hydroxyl group (—Ph—OH), and the like (n is, for example, 1 to 10, and preferably, 1 to 5). A part of the above-described sulfonate groups, the carboxylate groups, and the phosphate groups may be replaced by alkyl groups, sodium, potassium, calcium, and the like. The alkyl group and alkylene group contained in the above-described acid generating groups may include carbon atoms of 1 to 10 in number, and preferably carbon atoms of 1 to 5.

In order to introduce proton acid groups into the main skeleton of the aromatic hydrocarbon resin, various known functional-group introduction reactions can be utilized. For example, a sulfonating agent is used when introducing sulfonate groups. As the sulfonating agent, although not particularly limited, concentrated sulfuric acid, fuming sulfuric acid, chlorosulfuric acid, a sulfuric anhydride complex, and the like can be used conveniently, for example. When introducing carboxylate groups, an oxidation reaction, a hydrolytic reaction of carboxylate derivatives, a transfer reaction, and the like can be used. When introducing a phenolic hydroxyl group, substitution reactions of such as halogen, reduction reactions of such as quinone, and oxidation reactions of hydrocarbons, and the like can be used.

Also, for introducing proton acid groups to the main skeleton of the aromatic hydrocarbon resin, it is desirable to introduce proton acid groups into the monomer for producing the aromatic hydrocarbon resin before aromatic hydrocarbon resin polymerization. By introducing the proton acid group at the stage of a monomer, the sulfonate groups are uniformly introduced into the polymer chain, so that a good oxidation resistance is obtained; proton conductivity is easily controlled; and an electrolyte membrane with a definite quality can be manufactured. Moreover, introduction of the proton acid group is easier compared with the case when it is introduced into a polymer.

The proton acid groups are contained by 0.1 to 5 groups per unit skeleton forming the aromatic hydrocarbon resin, for example, preferably 0.5 to 4 groups, and more preferably 1 to 2 groups.

(1-2-3) Aromatic Hydrocarbon Resin having Proton Acid Groups

An aromatic hydrocarbon resin having preferable proton acid groups of the present invention has the structure expressed by following formula (I) 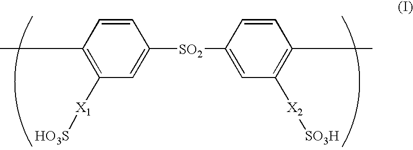
wherein X₁ and X₂ are either the same or different with each other, and are —(ROₘ)ₙ—, where R is an alkylene group, preferably an alkylene group of a straight chain or a branched chain with the carbons of 1 to 20 in number, more preferably of 1 to 10; m is 0 or 1; and n is an integer of 0 to 20, preferably of 0 to 10, and more preferably an integer of 1 to 5. The alkylene groups represented by above-described R may be partly replaced by a halogen group, a hydroxyl group, phenol and the like.

Further, an aromatic hydrocarbon resin having preferable proton acid groups of the present invention may have a structure of a divalent ether group expressed by the following formula (II): 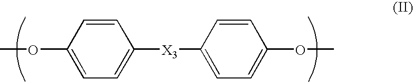
wherin X₃ is a single bond, —O—, —SO₂—, —CO—,

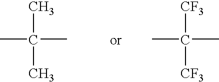

Moreover, an aromatic hydrocarbon resin having preferable proton acid groups of the present invention may have the structure of the group derived from the monomer/oligomer having three or more reaction groups, expressed by the following formulas (III) 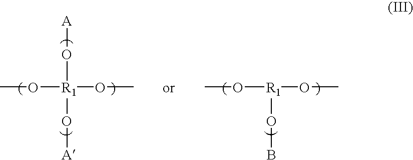
wherein R₁ and R₂ are groups consisting of C, H, and O. The molecular weight of the group shown above (III) is suitably, for example, 1000 or less, and preferably 100 to 500. Specifically, R₁ and R₂ include substituent groups formed by detaching 3 or 4 hydrogen groups from the compounds selected from among benzophenone, flavone, anthraquinone, pyridine, and R₃(Ph—)ₙ (where R₃ is an aliphatic group of straight or branched chain, an alicyclic group or an aromatic group, with saturated or unsaturated C₁ to C₁₀₀; and n is 3 or 4). More preferably R₂ is CH₃C(Ph—)₃.

The groups expressed by the above described formula (III) have bridging points at the positions of A, A′, and B. The group of formula (III) can construct a cross-bridge through this bridging point with the resin or the porous substrate contained in the electrolyte membrane of the present invention. An ether bond, an ester bond, an amide bond, a sulfone bond, a urea bond, an imide bond, a carbonyl bond, or a quinoxaline bond can be formed with these cross-bridges.

(1-2-4) Other Resins

Although the proton conductive polymer composition of the present invention may be a polymer composition consisting of only one kind out of above-described aromatic hydrocarbon resins, it may contain one or more kinds of resins other than above-described aromatic hydrocarbon resins within the range where the characteristics of the proton conductive polymer composition of the present invention are not remarkably lowered. By adding these, addition of flexibility to the proton conductive polymer composition may become possible. Also, an effect of preventing the proton conductive polymer composition that should be held in the pores of the porous substrate for suppressing the swelling of the electrolyte, from segregating (eluting) to the outside of pores, is obtained.

Specifically, such other resins include general-purpose resins, such as polyethylene (PE), polypropylene (PP), polystyrene (PS), polymethylmethacrylate (PMMA), an ABS resin, an AS resin and the like; engineering plastics such as polyacetate (POM), polycarbonate (PC), polyamide (PA: nylon), polyethylene terephthalate (PET), polybutylene terephthalate (PBT), and the like; thermoplastic resins, such as polyacrylonitrile, polyacrylic acid, polyphenylenesulfide (PPS), polyethersulfone (PES), polyketone (PK), polyimide (PI), polycyclohexanedimethanol terephthalate (PCT), polyarylate (PAR), various liquid crystal polymers (LCP) and the like; and thermosetting resins, such as an epoxy resin, a phenol resin, a novolak resin, a bismaleimide resin, and the like. Moreover, other resins noted here may have a structure having cross-bridging points which can combine with the resin or the base material contained in the electrolyte membrane of the present invention, in the structure of the resin.

The cross-bridging points are preferably reactive groups capable of forming an ether bond, an ester bond, an amide bond, a sulfone bond, a urea bond, an imide bond, a carbonyl bond, or a quinoxaline bond.

The number average molecular weight of other resins of the present invention is preferably 1,000 to 1,000,000, more preferably 5,000 to 500,000 from viewpoints of strength and workability of the obtained electrolyte membrane, and especially preferable to be 10,000 to 200,000. If the number average molecular weight is 1,000 or more, strength of the obtained electrolyte membrane can fully be maintained, and if it is 1,000,000 or less, sufficient workability can be held.

Other resins preferably exist in quantity of, for example, 0.01 to 90%, preferably 10 to 50%, of the proton conductive polymer composition. If it is 0.01% or more, it is preferable, since effects such as reduction of the swelling of the electrolyte and the methanol permeability are fully acquired. If it is 90% or less, it is preferable, since favorable proton conductivity is acquired.

(1-2-5) Other Additives

The proton conductive polymer composition of the present invention may contain various excipients, such as an antioxidant, a thermostabilizer, a lubricant, a tackifier, a plasticizer, a cross-linking agent, a viscosity control agent, an antistat, an antibacterial agent, an antifoamer, a dispersant, a polymerization inhibitor and the like, depending on the situation. Especially, the crosslinking agent includes an epoxy resin, bismaleimide, and an acrylate resin, for example.

These additives are preferably added at 0.01 to 50 weight % of the proton conductive polymer composition, and more preferably at 0.1 to 30 weight %.

(1-2-6) Constitution of the Proton Conductive Polymer Composition

As for the constitution of the proton conductive polymer composition, it is desirable that the aromatic hydrocarbon resin having proton acid groups is contained for example, in 50 weight % or more of the whole resin composition, and preferably in 70 weight % or more. If the quantity of the aromatic hydrocarbon resin is 50 weight % or more, a proton acid group concentration in the proton conductive polymer composition will fully be maintained and favorable proton conductivity can be obtained. Moreover, the phase of the aromatic hydrocarbon resin having proton acid groups does not turn into a non-continuous phase, so that the mobility of the conducting proton is not reduced and the situation is preferable,

(2) Electrolyte Membrane and Preparing Method Thereof.

An electrolyte membrane of the present invention is formed by introducing (filling, intercalating) the proton conductive polymer composition into the pores of the above described porous substrate, and making the proton conductive polymer composition being held (immobilized, supported) in the pores of the above-described porous substrate.

(2-1) A Method for Preparing an Electrolyte Membrane

Although the method of introducing the proton conductive polymer composition into the porous substrate is not particularly limited, it includes for example: (a) a method for polymerizing monomers and/or oligomers in the pores of the porous substrate and (b) a method of immersing the porous substrate to the solvent solution of the proton conductive polymer composition and introducing the proton conductive polymer composition into the pores of the porous substrate.

(a) Method for Polymerizing Monomers and/or Oligomers in the Pores of the Porous Substrate

A method for polymerizing monomers and/or oligomers in the pores of the porous substrate suitably comprises the following steps:

(1) a step of holding the monomers and/or the oligomers for forming the proton conductive polymer composition in the pores of the porous substrate, and

(2) a step of polymerizing the above-described monomers and/or the oligomers in the pores.

This polymerization method polymerizes the proton conductive polymer composition of the present invention inside the pores of the porous substrate, and by this method, the proton conductive polymer composition of the present invention can construct a bridge with the inside of the pores of the porous substrate, and segregation (elution) of the proton conductive polymer composition to the pore exterior can be prevented.

Moreover, at the time of polymerization, the proton conductive polymer composition of the present invention and the porous substrate can be made to react with each other. For example, when polyethersulfone, having a hydroxyl group as the reactive group on the cross-linking point, is used as the proton conductive polymer composition of the present invention, and polyimide is used as the porous substrate, the terminal hydroxyl group of the polyethersulfone and the unreacted polyamic acid in the polyimide porous substrate react with each other to form an ester bond, and a bridge can be constructed. Thus, reaction of the pores with the proton conductive polymer composition and construction of a bridge can suppress separation (elution) of the proton conductive polymer composition to the outside of pores.

It is appropriate for the monomer and/or the oligomer used here to have three or more reaction groups, preferably three or four reaction groups. Here, the reaction group includes a hydroxyl group, a carboxyl group and the like.

Also, the bridge formation is preferable to generate an ether bond, an ester bond, an amide bond, a sulfone bond, a urea bond, an imide bond, a carbonyl bond, and a quinoxaline bond. Especially, it is desirable to generate an ether bond and an ester bond.

This monomer includes molecules having three or more hydroxy groups, such as: 1,1,1-tris(4-hydroxyphenyl)ethane, 1,3,5-tris(4-hydroxyphenyl)benzene, 2,4,4′-trihydroxybenzophenone, 2,3,4-trihydroxybenzophenone, 4′,5,7-trihydroxyflavanone, 3,5,7-trihydroxyflavone, 4′, 5, 7-trihydroxyflavone, 5, 6, 7-trihydroxyflavone, 6-methyl-1,3,8-trihydroxyanthraquinone, 2,4,5-trihydroxypyridine, 2,2′,4,4′-tetrahydroxybenzophenone, and the like.

Further, the oligomer desirably contains two or more molecules of the above-described monomers, preferably 2 to 100 molecules.

The used-amount of the monomers and/or the oligomers having three or more reacting groups appropriately is, for example, 0.0001 to 80 mol % of the whole amount of the monomers and/or the oligomers used in the above-mentioned method for preparing the electrolyte membrane, preferably 0.001 to 50 mol %, and more preferably 0.01 to 40 mol %. If it is 80 mol % or less, the obtained electrolyte membrane has sufficient flexibility, and if it is 0.0001 mol % or more, it is preferable since sufficient effects are obtained as an electrolyte of the present invention.

In a specific reaction method, the monomers and/or the oligomers for forming the proton conductive polymer composition of the present invention are held in the pores. That is, the monomers and/or the oligomers for forming the proton conductive polymer composition of the present invention are prepared as it is, or as the solution dissolved in a solvent.

Here as the solvent, for example, toluene, acetone, N-methyl-2-pyrolydinone (NMP), dimethylformamide (DMF), dimethylsulfoxide (DMSO), dimethylacetamide (DMAc) and the like can be used. The porous substrate of the present invention is immersed in the monomers and/or the oligomers, or the solvent solution containing these, and the above-mentioned monomers and/or oligomers are made to be held in the pores of the porous substrate.

Subsequently, the monomers and/or the oligomers are polymerized in the pores. Conventional conditions for polymerizing the above-described monomers and/or the oligomers may be adopted as the polymerization conditions. For example, after heat treatment at 60 to 200° C., preferably 80 to 180° C. for 1 to 24 hours, preferably 2 to 12 hours, the temperature is raised up still higher than the above temperature to 150 to 250° C., preferably at 160 to 200° C. and held further for 8 to 64 hours, preferably for 12 to 48 hours.

When the polymerization is performed, sealing the pores of the porous substrate is preferable. “Sealing the pores” means prevention of dispersion of the solvent present in the pores. Sealing makes the solvent disperse less easily, and the solvent is removed slowly over the time during which the above-described polymerization takes place. Thus the “sealing” here does not mean a perfect sealing where a solvent does not disperse at all, but means a state where dispersion of the solvent is suppressed at least by 70%, preferably by 80% to 99.9%, more preferably by 90 to 99%, compared with the state where the dispersion is completely free. Sealing is performed by covering both surfaces of the substrate with a resin film such as non-porous polyimide, or a glass substrate, or the like.

After completion of the polymerization reaction, the substrate is rinsed by water, and vacuum-dried at 40 to 120° C., preferably at 80 to 100° C., for 0.5 to 10 hours, preferably for 1 to 5 hours to remove water, and the polymerized porous substrate is obtained,

(b) Method of Immersing the Porous Substrate in the Solvent Solution of the Proton Conductive Polymer Composition to Introduce the Proton Conductive Polymer Composition into the Pores of the Porous Substrate

A method of immersing the porous substrate in the solvent solution of the proton conductive polymer composition is suitable to comprise the following steps:

(1) a step of immersing the porous substrate in the solvent solution of the proton conductive polymer composition to introduce the proton conductive polymer composition into the pores of the porous substrate; and

(2) a step of keeping the porous substrate holding the proton conductive polymer composition at the temperature of 60° C. or more for at least 1 hour;

Specifically, the porous substrate is first immersed in a solvent solution of the proton conductive polymer composition. Thereby, the proton conductive polymer composition is introduced into the pores of the porous substrate.

The obtained solvent solution appropriately contains the proton conductive polymer composition, for example, in 5 to 50 weight %, preferably in 10 to 40 weight %. As the solvent, for example, toluene, acetone, N-methyl-2-pyrrolidinone (NMP), dimethylformamide (DMF), dimethylsulfoxide (DMSO), dimethylacetamide (DMAc) and the like can be used. Utilizing acetone is especially preferable, since impurities in the porous substrate and in the solvent solution can be removed. Moreover, when the porous substrate is immersed, they are preferably immersed under the pressure reduction and degassing. In addition, in order to form bridges between a part of the pores and a part of the proton conductive polymer composition, a cross-linking agent may be added. In order to form bridges, aromatic hydrocarbon resins, including bismaleimide, epoxy groups and acrylate are preferably used as the proton conductive polymer composition.

Next, the porous substrate holding the proton conductive polymer composition is heat-treated. By this heat treatment, the proton conductive polymer composition is further introduced into the pores of the porous substrate, the solvent is removed, and the proton conductive polymer composition is filled up and fixed within the pores.

The above-described heat treatment temperature is suitable, for example, to be 60° C. to 200° C., and preferably 80° C. to 180° C. And, the heat treatment is suitably conducted at least for 1 hr, for example for 1 to 36 hrs, preferably for 1 to 30 hrs, and more preferably for 2 hrs to 24 hrs. By setting the temperature to 60° C. or higher, the proton conductive polymer composition can be promptly introduced into, and fixed within the pores of the porous substrate. If the heat treatment is conducted for 1 hr or longer, the proton conductive polymer composition sufficiently permeates into the pores, and if it is for 36 hrs or shorter, the porous substrate is not pyrolyzed.

It is preferable that the pores of the porous substrate are sealed during the heat treatment. Sealing makes the solvent disperse less easily, and the solvent is removed slowly over the time of the above-described heat treatment. By sealing in this way, more proton conductive polymer compositions will be introduced into the pores of the porous substrate, without the proton conductive polymer compositions depositing on the surface of the porous substrate. Here, the “sealing” does not mean a perfect sealing where a solvent does not disperse at all, but means a state where dispersion of the solvent is suppressed at least by 70%, preferably by 80% to 99.9%, more preferably by 90 to 99%, compared to the state where the dispersion of the solvent is completely free. Sealing is performed by covering both surfaces of the porous substrate with a resin membrane such as non-porous polyimide, or a glass substrate, or the like.

The electrolyte membrane obtained as described above are processed by a known treatment, such as sulfonation, chlorosulfonation, phosphonium addition, hydrolysis, or the like, if necessary, so that a desired cation exchange group can be introduced into the proton conductive polymer composition in the electrolyte membrane, to be a cation-exchange-resin membrane.

(2-2) Properties of the Electrolyte Membrane

The obtained electrolyte membrane is a membrane in which the proton conductive polymer composition of the present invention is held in all or a part of the pores of the porous substrate. The “held” means: a state where the proton conductive polymer composition has entered in the pores, and cannot come out from the pores, although the pores and the proton conductive polymer composition have not been chemically bonded; and a state where the pores and the proton conductive polymer composition are chemically bonded, and the proton conductive polymer composition is immobilized in the pores; or the like. The latter “immobilized” includes a case where a part of the pores of the porous substrate, such as, for example, a part of functional groups of the polymer constituting the porous substrate, and a part of an aromatic hydrocarbon resin having proton acid groups which constitutes the proton conductive polymer compositions, such as, for example, a part of functional groups of the polymer which constitutes aromatic hydrocarbon resin, are bonded, and the pores and the proton conductive polymer composition are fixed with each other.

Although the obtained electrolyte membrane can be made into arbitrary thickness dependent on the purpose, it is preferable with regard to the proton conductivity, to be thin as much as possible. Specifically, the dry thickness is 5 to 200 μm, preferably 5 to 75 μm, and more preferably 5 to 50 μm, for example. If the thickness of the electrolyte membrane is 5 μm or more, handling of the electrolyte membrane is easy and the short-circuit problem of the fuel cell using this electrolyte membrane is avoided; and if it is 200 μm or less, the electric resistance of the electrolyte membrane can be suppressed lower and the power generation performance of the fuel cell using this electrolyte membrane can be improved excellently. Also, a layer of the proton conductive polymer composition may be further formed on the surface of the electrolyte membrane of the present invention.

When conductivity of the electrolyte membrane of the present invention is high, it is also possible to delete several μm of the surface layer, such as by grinding both surfaces of the membrane or by sandblasting both surfaces, and the like. Such polish of the membrane and deletion of the surface layers lead also to the improvement of adhesiveness at the time of attaching an electrode catalyst layer on the electrolyte membrane of the present invention.

The electrolyte membrane of the present invention may be heterogeneous about a cross section of the membrane, in order to reduce the electric resistance of the membrane. That is to say, like a reverse osmotic membrane, only one surface portion of the membrane may be of a minute structure (void content of 10 to 60%, preferably of 20 to 50%, an average pore diameter of 0.001 to 10 μm, preferably of 0.01 to 5 μm); and the inside and the opposite side surface may be porous (void content of 30 to 90%, preferably of 40 to 80%, an average pore diameter of 0.01 to 100 μm, preferably of 0.1 to 5 μm). An especially preferable structure of the electrolyte membrane of the present invention for use as the reverse osmotic membrane is a structure wherein both the membrane surfaces is of minute structure as described above and the inside is porous as described above.

(3) Membrane Electrode Assembly

A membrane electrode assembly of the present invention includes the above-described electrolyte membrane and an electrode(s) provided at least on one side of this electrolyte membrane, usually on both sides of the electrolyte membrane.

(3-1) Electrode

An electrode of the present invention has a gas-diffusion layer and a catalyst layer placed on and/or inside this gas-diffusion layer.

(3-1-1) Gas-Diffusion Layer

For a gas-diffusion layer, known substrates having gas-permeability, such as carbon fiber textile fabrics, carbon papers and the like, may be used, for example. Preferably, these substrates treated with a water-repellent are used. A water repellent treatment is performed, for example, by immersing these substrates in the aqueous solution of the water repellent consisting of fluororesins, such as polytetrafluoroethylene, tetrafluoroethylene-hexafluoropropylene copolymer and the like, and then drying and calcinating.

(3-1-2) Catalyst Layer

As catalytic substances used for the catalyst layer, for example, platinum metals, such as platinum, rhodium, ruthenium, iridium, palladium, and osnium, and their alloys are suitable. These catalytic substances and the salts of catalytic substances may be used independently or by mixing them. Among them, metal salts and complexes, especially, the ammine complexes expressed by [Pt (NH₃)₄] X₂ or [Pt (NH₃)₆] X₄ (X is a monovalent anion) are preferable. Moreover, when metal compounds are used as catalysts, a mixture of some compounds may be used, or double salts may be sufficient. For example, formation of a platinum-ruthenium alloy can be expected at a reduction step, when the mixture of a platinum compound and a ruthenium compound are used.

Although the particle size of a catalyst is not limited in particular, a mean particle diameter is preferable to be 0.5 to 20 nm from the viewpoint of the suitable magnitude for high catalytic activity. In addition, a study by K. Kinoshita et al. (J. Electrochem. Soc., 137, 845 (1990)) reported that the platinum particle size highly active for reduction of oxygen is about 3 nm.

To the catalyst used in the present invention, a co-catalyst can be further added. A co-catalyst may be a fine carbon powder. The fine carbon powder that makes the co-existing catalyst exhibit a high activity is preferable, and when a platinum metal compound is used as the catalyst, for example, acetylene black and the like, such as Denka Black, Valcan XC-72 and Black Pearl 2000 may be suitable.

Although quantity of the catalyst varies depending on adhesion methods or the like, it is appropriate that the catalyst is attached on the surface of a gas diffusion layer in the range of about 0.02 to about 20 mg/cm², and preferably about 0.02 to about 20 mg/cm². Moreover, the catalyst is appropriate to exist in the quantity of 0.01 to 10 weight % of the total amount of the electrodes, and preferably 0.3 to 5 weight %, for example.

(3-1-3) Binder

The electrode of the present invention is preferable to have a binder inside and/or on the surface of the electrode. Such a binder promotes binding of the above-described gas-diffusion layer and the catalyst layer, and binding of the electrode and the electrolyte membrane. As a binder, all the polymers possible to be used in the present invention, for example, and in addition, solid polymer electrolytes of fluorine base and the like, such as Nafion (R) and Flemion (R), can be used.

(3-1-4) Properties of the Electrode

The obtained electrode is porous, whose average pore size is suitable, for example, to be 0.01 to 50 μm, and preferably 0.1 to 40 μm, and the void content is, for example, suitable to be 10 to 99%, and preferably 10 to 60%.

(3-2) Fabrication of Membrane Electrode Assembly

A membrane electrode assembly of the present invention is fabricated by setting the above-mentioned electrode on the electrolyte membrane. Preferably, the catalyst layer side of the electrode is joined to the electrolyte membrane side. As the methods for fabricating this membrane electrode assembly, the following three methods are included, for example.

(a) A method of: forming a catalyst layer by applying directly the catalytic substances to the electrolyte membrane; and further forming a gas-diffusion layer on the catalyst layer formed.

For example, there is a method wherein: as described in JP-A-2000-516014, a catalyst layer is formed by applying catalytic substances containing perfluorocarbon polymers having ion exchange groups, a platinum group catalyst, fine carbon powder (carbon black), excipients and the like by spreading, spraying, printing, or the like on the electrolyte membrane, and then the gas-diffusion layer is thermally attached on the catalyst layer with hot press and the like.

(b) A method of: forming in advance the catalyst layer by applying the catalytic substances on a substrate; transcribing the obtained catalyst layer on the electrolyte membrane; and further forming a gas-diffusion layer on the constructed catalyst layer.

For example, there is a method wherein: polytetrafluoroethylene and platinum black synthesized with Thomas method or the like are mixed uniformly beforehand; the mixture is applied on a Teflon (registered trademark) sheet substrate and pressure-molded; which is transcribed on the electrolyte membrane; a gas-diffusion layer is further arranged; and the obtained laminated product is pressure-attached with each other.

(c) A method of: immersing a gas-diffusion layer in the solution of the catalytic substances to form an electrode beforehand; and setting the obtained electrode on the electrolyte membrane.

For example, there is a method in which: a gas-diffusion layer is immersed in the solution (the paste) of a soluble platinum group salt to allow the soluble platinum group salt being adsorbed (ion exchanged) on and inside the gas-diffusion layer; and subsequently, the layer is immersed in a solution of a reducing agent such as hydrazine or Na₂BO₄ to allow the catalyst metal to deposit on the gas-diffusion layer.

More preferable fabricating methods of a membrane electrode assembly of the present invention include a method of applying the electrode material containing the catalytic substances and the gas-diffusion layer material directly on the electrolyte membrane. Specifically, catalyst-carrying carbon particles possessing a catalytic substance such as platinum-ruthenium (Pt—Ru), platinum (Pt) and the like, are used as the catalytic substance. This catalytic substance is mixed with a solvent like water, a binder such as a solid polymer electrolyte, and optionally a water repellent such as polytetrafluoroethylene (PTFE) particles used for preparing the gas-diffusion layer, to produce a paste. Applying this paste directly on the electrolyte membrane of the present invention with spreading or spraying, to form a film, then it is heat-dried to form a catalyst layer (when a water repellent is included, the water-repellent layer constituting a part of the gas-diffusion layer is included) on the polymer electrolyte. An electrode is constructed on this catalyst layer by hot pressing a gas-diffusion layer such as a carbon paper optionally treated with a water-repellent.

In this case, the thickness of the catalyst layer is suitable to be, for example, 0.1 to 1000 μm, preferably 1 to 500 μm, and more preferably 2 to 50 μm.

The viscosity of above-described paste is desirable to be adjusted in the range from 0.1 to 1000 Pa·S. This viscosity can be adjusted by: (i) choosing each particle size; (ii) adjusting composition of the catalyst particle and the binder; (iii) adjusting the content of water; or (iv) preferably, adding a viscosity modifier, such as carboxymethyl cellulose, methyl cellulose, hydroxyethyl cellulose and cellulose or the like, and polyethyleneglycol, polyvinylalcohol, polyvinylpyrrolidone, sodium polyacrylate, and polymethylvinylether, or the like.

(4) Fuel Cell

A fuel cell of the present invention uses the above-mentioned membrane electrode assembly. The fuel cell of the present invention includes a solid polymer fuel cell (PEFC) and a direct methanol supply fuel cell (DMFC).

Also, the method for preparing the fuel cell of the present invention includes a step of arranging the above-described electrolyte membrane between two electrodes to obtain membrane electrode assembly.

Specifically, a fuel cell is constructed, for example, by procedures wherein: a catalyst layer is attached to each face of the electrolyte membrane of the present invention; two polar plates, an anode and a cathode, are further arranged or supported on each face of the membrane electrode assembly which is further equipped with gas-diffusion layers; a fuel chamber capable of keeping ordinary pressure or compressed hydrogen gas, compressed methanol gas or methanol aqueous solution, is arranged on one face of the obtained multilayer body; and a gas chamber capable of keeping ordinary pressure or compressed oxygen or air, is arranged on another face of the multilayer body. From the fuel cell constructed in this way, electrical energy generated by the reaction of hydrogen or methanol with oxygen can be taken out.

Moreover, in order to take out required electric power, many units may be arranged in series or in parallel, assuming this membrane electrode assembly or the multi-layered body as one unit.

### EXAMPLES

Hereafter, examples are given for explaining the present invention in more detail, but the present invention is not limited to these examples.

### Example 1

A polyimide membrane substrate (made by Ube Industries: trade name UPILEX-PT, void content 50%, thickness 30 μm), which is a sufficiently degassed porous substrate, was immersed in a solution in toluene and N-methyl-2-pyrrolidinone, of the monomers for forming the proton conductive polymer composition given in Table 1. Then, the porous substrate surface was covered with a glass plate, and was heat-treated at 160° C. for 4 hrs. Subsequently, the temperature was raised up to 180° C. and was kept for further 16 hours. Then, it was rinsed, vacuum-dried at 80° C. for 2 hrs to remove water, and the pores of the polyimide membrane was filled up with sulfonated polyethersulfone (S-PES polymer). Then, it was washed enough with water and was immersed in a 1 N sulfuric acid solution for 24 hours. After immersion, it was dried to obtain the electrolyte membrane of the present invention. From the difference of the weight after filled up with the proton conductive polymer composition, the polymerization rate was 19.0% and the thickness of the electrolyte membrane was 33 μm.

TABLE 1

| | Weight | Molar |
|---|---|---|
| Component | ratio | Ratio |
| 4,4′-dihydroxy-3,3′- | 203.6 | 0.4 |
| disulfonic acid | | |
| diphenylsulfone sodium | | |
| salt | | |
| Bis (4-chlorophenyl) | 172.6 | 0.6 |
| sulfone | | |
| 4,4′-dihydroxydiphenyl | 200.1 | 0.99 |
| ether | | |
| 1,1,1,-tris (4- | 2.04 | 0.0066 |
| hydroxyphenyl) ethane | | |
| potassium carbonate | 1.5 | 1.5 |
| N-methyl-2-pyrrolidinone | 3234.6 | |
| toluene | 1347.7 | |

### Example 2

1.213 g of 4,4′-dihydroxydiphenyl ether, 0.688 g of bis (4-chlorophenyl) sulfone, 1.832 g of 4,4′-dihydroxy-3,3′-disulfonic acid diphenylsulfone sodium salt, 1.24 g of potassium carbonate, 20 ml of N-methylpyrrolidone were loaded in a 50 ml four mouth round bottom flask equipped with Dean Stark traps, condensers, agitators, and nitrogen feed-pipes. This mixture was heated to 100° C. in an oil bath, then 20 ml of toluene was added, and heated to 160° C., reflaxed for 4 hours to remove toluene. The oil bath was heated to 180° C. to remove the toluene, and polymerization was also continued at 180° C. for 24 hrs. After cooling, this solution was poured into 250 ml of water to deposit polymer, and then this polymer was rinsed and dried (90% yield). The obtained polymer (powder) was re-dissolved into N-methyl-2-pyrrolidinone, and the polyethersulfone solution (20% of solid content) was prepared. The number average molecular weight measured using the gel permeation chromatography (GPC) was 47,000 (polystyrene equivalent).

A polyimide membrane (made by Ube Industries: tradename UPILEX-PT, void content 50%, thickness 30 μm), which is a sufficiently degassed porous substrate, was immersed in N-methyl-2-pyrrolidinone, and then the substrate surfaces were covered with glass plates, and heat-treated at 180° C. for 10 hrs. After heat treatment, the polyimide membrane was pulled up from N-methyl-2-pyrrolidinone, dried to remove N-methyl-2-pyrrolidinone, and the polyimide membrane was further immersed in the polyethersulfone solution (20%) produced as described above. The substrate surfaces were covered with glass plates, and heat-treated at 180° C. for 12 hrs to remove the solvent. Subsequently, it was rinsed, vacuum-dried at 80° C. for 2 hrs to remove water, and thus the pores of the polyimide membrane were filled up with sulfonated polyethersulfone (S-PES polymer). Then, the membrane was washed enough with water and was immersed in a 1 N sulfuric acid solution for 24 hours. After immersion, it was dried and the electrolyte membrane of the present invention was obtained. From the difference of the weight after filled up with the proton conductive polymer composition, the filling rate was 28% and the thickness of the electrolyte membrane was 36 μm.

### Comparative Example 1

The polyethersulfone solution (solid content 20%) produced in the Example 2 was cast on a glass substrate, and was flown-extended on the glass plate. Subsequently, it was dried at 100° C. for 30 min and at 160° C. for 1 hr to remove the solvent. Then, the substrate was immersed in a 1 N sulfuric acid solution for 24 hours, and 50 μm thick electrolyte membrane was obtained. A porous substrate was not used.

### Comparative example 2

Commercial Nafion 117 (175 μm thick) was used. A porous substrate was not used.

Evaluation

The obtained electrolyte membranes of the examples and the comparative examples were cut off in the dimensions of 2 cm×2 cm, and area change rate, oxidation resistance, shape stability, proton conductivity, and methanol permeability were estimated by the methods shown below.

(i) Area Change Rate

Electrolyte membranes were immersed in pure water at 25° C. for 24 hours, and area change rates (%) before and after immersion was determined. When the area change rate was 20% or less, and preferably 10% or less, the electrolyte membrane was estimated to be good.

(ii) Oxidation Resistance

Electrolyte membranes were immersed in the solution containing 3 weight % of H₂O₂ and 5 ppm of FeSO₄ at 80° C. for 1 hr, and the weight change rates before and after immersion were determined. When the weight change rate was 10% or less, oxidation resistance was judged to be good, and when larger than 10%, the oxidation resistance was judged to be poor.

(iii) Shape Stability

Electrolyte membranes were vacuum-dried at 120° C. for 2 hrs, then immersed in pure water of 60° C. for 2 hrs, taken out of the pure water, and the curvatures of electrolytes were examined. Radii of curvatures of the electrolytes were measured, and when the radius was 2 cm or more, shape stability was judged to be good, and when it was less than 2 cm, the shape stability was judged to be poor.

(iv) Proton Conductivity

The electrolyte membrane was cut off in a strip shape of 10 mm×30 mm, its both ends were clasped by platinum boards (5 mm×50 mm), and it was supported with a measuring probe made of Teflon (registered trademark). The resistance between the platinum boards was measured on this supported multilayer body by 1260 FREQUENCY RESPONSE ANALYSER made by SOLARTRON, in the atmosphere of 30° C. and 100% humidity, and proton conductivity was calculated using the following formula.
proton conductivity [S/cm]=gap between platinum boards [cm]/(membrane width [cm]×membrane thickness [cm]×resistance [Ω])

If the proton conductivity is 0.01 Sm⁻¹ or more, and preferably 0.03 Sm⁻¹ or more, it can be said that the electrolyte membrane has good proton conductivity.

(v) Methanol Permeability

With the method of Yamaguchi et al. (J. Electrochem. Soc., 2002, 149, A1448-1453), measurements were done at 25° C. and 80° C. using 10 to 60 weight % methanol aqueous solutions. Amount of methanol permeated through the electrolyte membrane was measured by the gas chromatography, and the permeated methanol amount was plotted against time. The methanol permeation flow rate J was obtained from the gradient of this plot, and the methanol permeation coefficient P was computed from this methanol permeation flow rate J according to the following formula which takes the thickness of the electrolyte membrane into consideration:
p=J×l

(P: methanol permeation coefficient (kg μm/m²h), J: methanol permeation flow rate (kg/m²h), 1: membrane thickness. (μm)). When the methanol permeation coefficient P was 50 kg μm/m²h or less, it was evaluated as good (methanol permeability is good) and when more than 50 kg μm/m²h, it was evaluated as poor.

Results of the evaluation of the above-described (i)-(v) are shown in the following Tables 2 and 3.

TABLE 2
Area change rate, oxidation resistance, shape
stability, and proton conductivity,

| | Area | | | |
|---|---|---|---|---|
| | change | | | Proton |
| | rate | Oxidation | Shape | conductivity |
| | (%) | resistance | stability | (Sm⁻¹) |
| Example 1 | (1 | Good | Good | 0.044 |
| Example 2 | (1 | Good | Good | 0.065 |
| Comparative | 30 | Poor | Poor | 0.08 |
| example 1 | | (Weight | | |
| | | change rate | | |
| | | 50%) | | |
| Comparative | 20 | Good | Good | 0.076 |
| example 2 | | | | |

TABLE 3
Methanol permeability (inside of parenthesis is
methanol permeation coefficient (kg μm/m²h))

| | Measurement temperature | | | | | |
|---|---|---|---|---|---|---|
| | 25° C. | | | 80° C. | | |
| | Methanol concentration (%) | | | | | |
| | 10 | 30 | 60 | 10 | 30 | 50 |
| Example 1, | Good | Good | Good | Good | Good | Good |
| | (<1) | (<1) | (1.6) | (4.2) | (7.6) | (50) |
| Example 2, | Good | Good | Good | Poor | Poor | Poor |
| | (1.9) | (6) | (10) | | | |
| Comparative | Poor | Poor | Poor | Poor | Poor | Poor |
| example 1, | | | | | | |
| Comparative | Poor | Poor | Poor | Poor | Poor | Poor |
| example 2, | | | | | | |

Table 2 and Table 3 show that the examples 1 and 2, in which the proton conductive polymer composition of the present invention was filled into the porous substrate, show excellent characteristics in the area change rate, the oxidation resistance, the shape stability, and the methanol permeability, without spoiling the proton conductivity. Especially, it was found that the methanol permeability shows excellent characteristics also at 80° C. The above reasons are considered as follows. The monomers were polymerized within the pores whose swelling could be suppressed due to the cross-linked structure, and so, when polymerized within the pores, the monomers reacted with the functional groups of the porous substrate existing in the pores, such as polyamic acid on the pore surfaces.

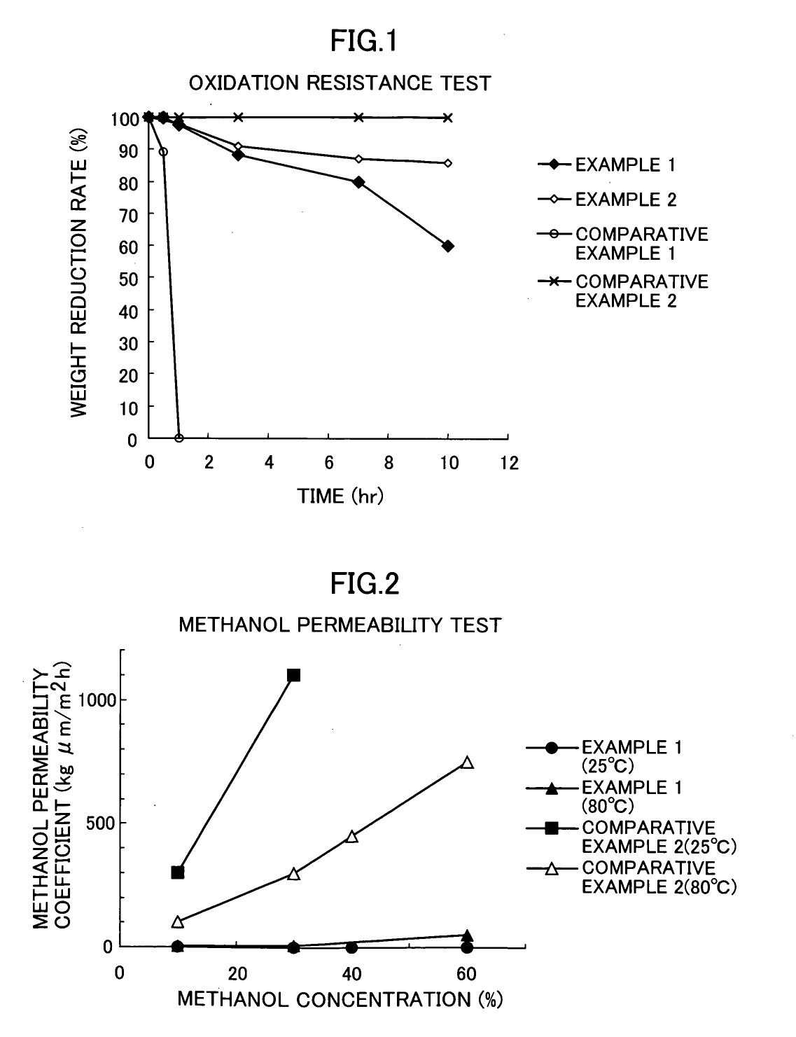

Furthermore, additional experiments were performed about (ii) the oxidation resistance and (v) the methanol permeability, and were evaluated. First, the oxidation resistance of the electrolyte of each example and comparative example was shown in FIG. 1 as the relation between the weight change rate and the elapsed time, when it was immersed in the solution containing 3 weight % of H₂O₂ and 5 ppm of FeSO₄ at 50° C. The weight reduction rate in FIG. 1 shows the weight in % after immersion, when the weight before immersion is set 100%. Therefore, if the weight reduction rate is 90%, the weight change rate is 10%.

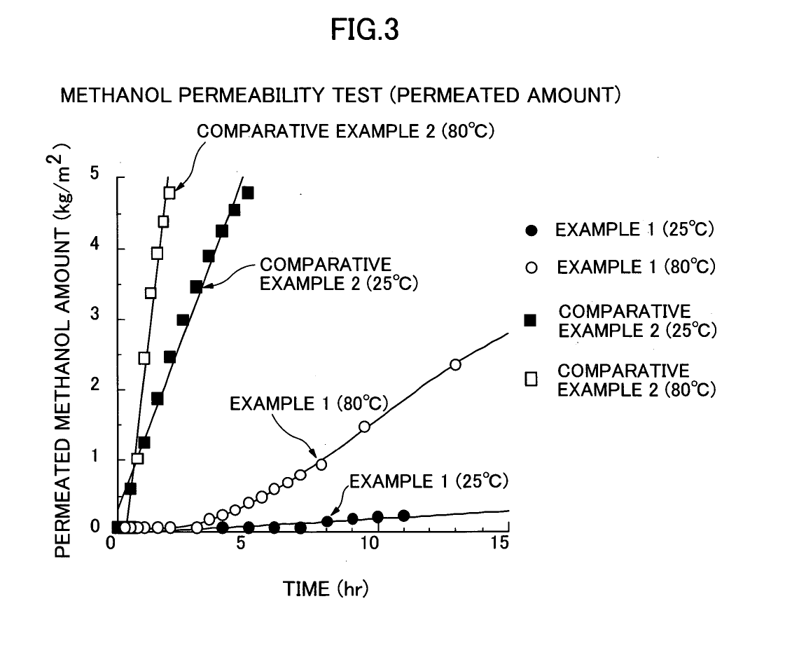

Taking up Example 1 and Comparative example 2 as examples, the methanol permeability was shown in FIG. 2 as the relation between the methanol concentration and the methanol permeability coefficient. Furthermore, the relation between the time and the amounts of permeated methanol, when using a 30 weight % aqueous methanol solution, was shown in FIG. 3.

What is claimed is:

1. An electrolyte membrane comprising a porous substrate having a plurality of pores and a proton conductive polymer composition held in said pores, wherein said proton conductive polymer composition contains an aromatic hydrocarbon resin having proton acid groups.

2. The electrolyte membrane according to claim 1, wherein said aromatic hydrocarbon resin is selected from a group consisting of polysulfone, polyethersulfone, polyarylate, polyamide imide, polyetherimide, polyimide, polyquinoline, and polyquinoxaline.

3. The electrolyte membrane according to claim 1, wherein said aromatic hydrocarbon resin is polyethersulfone.

4. The electrolyte membrane according to claim 1, wherein said proton acid group is selected from a group consisting of a sulfonate group, a carboxylate group, a phosphate group, and a phenolic hydroxyl group.

5. The electrolyte membrane according to claim 1, wherein said aromatic hydrocarbon resin comprises a structure given by formula (I) 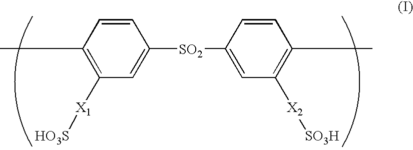
wherein X₁ and X₂ are either the same or different with each other, and are —(ROₘ)ₙ—, where R is an alkylene group, m is 0 or 1, and n is an integer of 0 to 20.

6. The electrolyte membrane according to claim 1, wherein said porous substrate is an inorganic material or a heat-resistant polymer.

7. The electrolyte membrane according to claim 1, wherein said porous substrate is polyimide and said aromatic hydrocarbon resin is polyethersulfone.

8. The electrolyte membrane according to claim 1, wherein said proton conductive polymer composition contains a cross-linking agent.

9. The electrolyte membrane according to claim 1, wherein a part of said pores and a part of said aromatic hydrocarbon resin are fixed.

10. The electrolyte membrane according to claim 1, wherein the area change rate of said electrolyte membrane after immersion in water at 25° C. for 24 hours is 10% or less; the weight change rate after immersion in a solution containing 3 weight % of H₂O₂ and 5 ppm of FeSO₄ at 80° C. for 1 hour is 10% or less; and the proton conductivity is 0.01 S/cm or more.

11. A method for preparing the electrolyte membrane according to claim 1, comprising:
(1) a step of holding monomers and/or oligomers for forming said proton conductive polymer composition in said pores of said porous substrate; and
(2) a step of polymerizing said monomers and/or an oligomers in said pores.

12. The method for preparing the electrolyte membrane according to claim 11, wherein each of the monomers and/or the oligomers for forming said proton conductive polymer composition has three or more reactive groups.

13. A method for preparing the electrolyte membrane according to claim 1, comprising:
(1) a step of immersing said porous substrate in a solvent solution of said proton conductive polymer composition, to introduce said proton conductive polymer composition into said pores of said porous substrate; and
(2) a step of keeping said porous substrate holding said proton conductive polymer composition at the temperature of 60° C. or higher for at least 1 hour.

14. A membrane electrode assembly using the electrolyte membrane according to claim 1.

15. A fuel cell using the membrane electrode assembly according to claim 14.
